(19) United States
(12) Patent Application Publication
(10) Pub. No.: US 2024/0177645 A1
(43) Pub. Date: May 30, 2024

(54) DISPLAY DEVICE

(71) Applicant: Samsung Display Co., Ltd., Yongin-Si (KR)

(72) Inventor: KYUNG-HUN LEE, Yongin-si (KR)

(21) Appl. No.: 18/371,450

(22) Filed: Sep. 22, 2023

(30) Foreign Application Priority Data
Nov. 28, 2022 (KR) 10-2022-0161670

(51) Int. Cl. G09G 3/20; G09G 3/3233

(52) U.S. Cl. CPC G09G 3/2007; G09G 3/3233; G09G 2300/0819; G09G 2300/0842; G09G 2310/08; G09G 2320/0233; G09G 2320/0242; G09G 2320/041; G09G 2320/0626; G09G 2330/021

(57) ABSTRACT

Disclosed is a display device including a display panel, a temperature calculator, and a data compensator. The display panel includes a plurality of pixels. Each of the pixels includes one of a first light emitting element, a second light emitting element, and a third light emitting element. The temperature calculator senses a block temperature for each of a plurality of block areas partitioned in the display panel and calculates temperature of each of the plurality of pixels based on the block temperature. The data compensator generates compensation image data by compensating for image data corresponding to each of the pixels depending on the temperature.

### CROSS-REFERENCE TO RELATED APPLICATIONS

This application claims priority under 35 U.S.C. § 119 to Korean Patent Application No. 10-2022-0161670 filed on Nov. 28, 2022, in the Korean Intellectual Property Office, the disclosures of which are incorporated by reference herein in their entireties.

### BACKGROUND

The present disclosure relates to a display device, and more particularly, relates to a display device having uniform display characteristics even when temperature is changed.

A light emitting display device displays an image by using a light emitting diode that generates a light through the recombination of electrons and holes. The light emitting display devices have a fast response speed and operate with low power consumption.

A light emitting display device includes pixels connected to data lines and scan lines. In general, each of the pixels includes a light emitting element and a pixel circuit unit for controlling the amount of current flowing to the light emitting element. In response to a data signal, the pixel circuit unit may control the amount of current that flows from a terminal, to which a first driving voltage is applied, to a terminal, to which a second driving voltage is applied, via the light emitting element. In this case, a light having predetermined luminance is generated to correspond to the amount of current flowing through the light emitting element.

### SUMMARY

Embodiments of the present disclosure may provide a display device for preventing degradation of display characteristics according to temperature.

According to an embodiment, a display device includes a display panel, a temperature calculator, and a data compensator. The display panel includes a plurality of pixels. Each of the pixels includes one of a first light emitting element, a second light emitting element, and a third light emitting element.

The temperature calculator senses a block temperature for each of a plurality of block areas partitioned in the display panel and calculates temperature of each of the plurality of pixels based on the block temperature. The data compensator generates compensation image data by compensating for image data corresponding to each of the pixels depending on the temperature.

According to an embodiment, a display device includes a display panel and one or more integrated circuits. The display panel includes a plurality of pixels. Each of the pixels includes one of a first light emitting element, a second light emitting element, and a third light emitting element. The one or more integrated circuits are configured to: sense a block temperature for each of a plurality of block areas partitioned in the display panel; calculate temperature of each of the plurality of pixels based on the block temperature; generate compensation image data; and compensate an image using the compensation image data corresponding to each of the pixels depending on temperature.

### BRIEF DESCRIPTION OF THE FIGURES

The above and other objects and features of the present disclosure will become apparent by describing in detail embodiments thereof with reference to the accompanying drawings.

FIG. 1 is a perspective view of a display device, according to an embodiment of the present disclosure.

FIG. 2 is an exploded perspective view of a display device, according to an embodiment of the present disclosure.

FIG. 3A is a block diagram of a display device, according to an embodiment of the present disclosure.

FIG. 3B is a block diagram showing a driving controller and a source driver shown in FIG. 3A.

FIG. 4A is a circuit diagram illustrating a pixel, according to an embodiment of the present disclosure.

FIG. 4B is a waveform diagram for describing an operation of a pixel and a sensing period shown in FIG. 4A.

FIG. 4C is a graph showing driving characteristics according to temperature of a pixel, according to an embodiment of the present disclosure.

FIG. 5A is a plan view of a display device, according to an embodiment of the present disclosure.

FIG. 5B is a waveform diagram illustrating operations of sensing scan lines, according to an embodiment of the present disclosure.

FIG. 6 is a block diagram of a display device, according to an embodiment of the present disclosure.

FIG. 7A is an internal block diagram of a driving controller, according to an embodiment of the present disclosure.

FIG. 7B is an internal block diagram of a data compensator, according to an embodiment of the present disclosure.

FIG. 8A is a diagram, in which a display device displays a peak white image, according to an embodiment of the present disclosure.

FIG. 8B is a diagram, in which a display device individually displays a peak red image, a peak green image, and a peak blue image, according to an embodiment of the present disclosure.

FIG. 9 is an internal block diagram of a driving controller, according to an embodiment of the present disclosure.

FIG. 10A is a diagram, in which a display device individually displays a peak yellow image, a peak magenta image, and a peak cyan image, according to an embodiment of the present disclosure.

FIG. 10B is a diagram, in which a display device displays a red image, according to an embodiment of the present disclosure.

### DETAILED DESCRIPTION

In the specification, the expression that a first component (or region, layer, part, portion, etc.) is “on”, “connected with”, or “coupled with” a second component means that the first component is directly on, connected with, or coupled with the second component or means that a third component is interposed therebetween.

The same reference numerals refer to the same components. Also, in drawings, the thickness, ratio, and dimension of components are exaggerated for effectiveness of description of technical contents.

As used herein, the word “or” means logical “or” so that, unless the context indicates otherwise, the expression “A, B, or C” means “A and B and C,” “A and B but not C,” “A and C but not B,” “B and C but not A,” “A but not B and not C,” “B but not A and not C,” and “C but not A and not B.”

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The articles “a,” “an,” and “the (sometimes)” are singular in that they have a single referent, but the use of the singular form in the specification should not preclude the presence of more than one referent.

Also, the terms “under”, “below”, “on”, “above”, etc. are used to describe the correlation of components illustrated in drawings. The terms that are relative in concept are described based on a direction shown in drawings.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in the specification have the same meaning as commonly understood by one skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

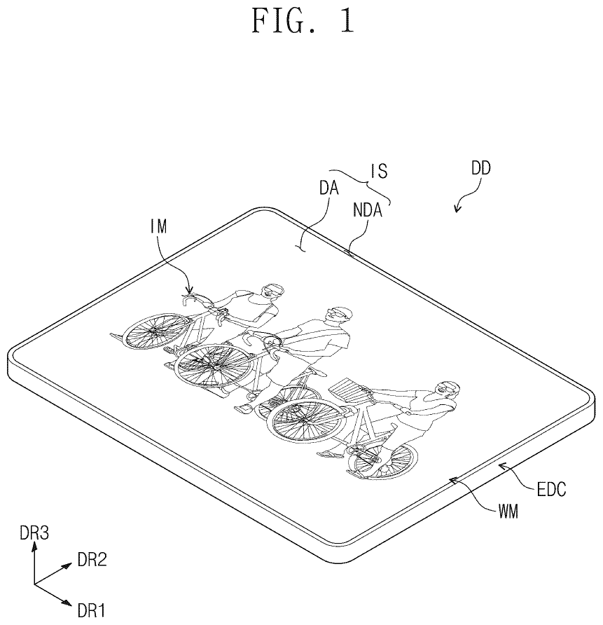

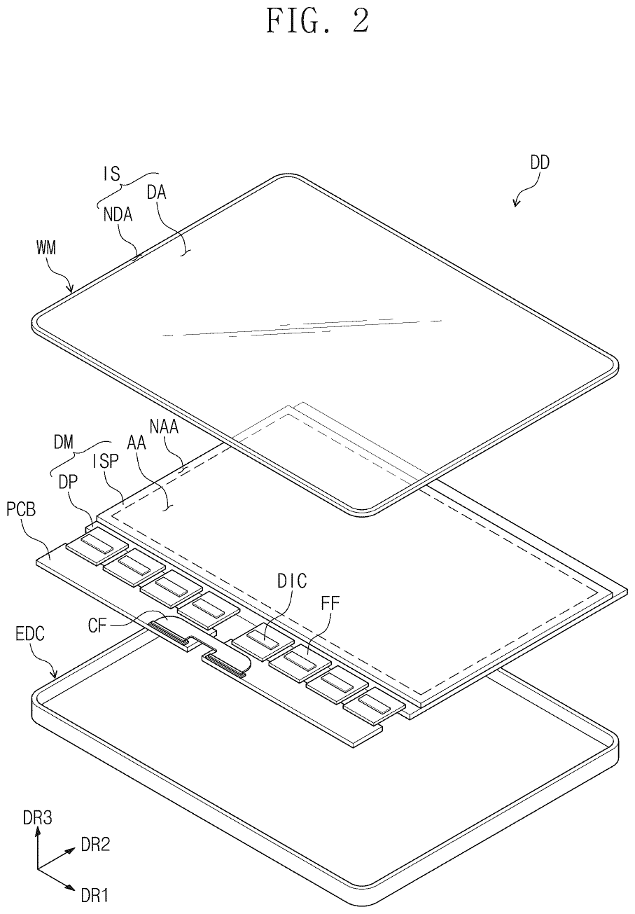

FIG. 1 is a perspective view of a display device, according to an embodiment of the present disclosure. FIG. 2 is an exploded perspective view of a display device, according to an embodiment of the present disclosure.

Referring to FIGS. 1 and 2, a display device DD may be a device activated depending on an electrical signal. The display device DD according to the present disclosure may be a small and medium-sized electronic device, such as a mobile phone, a tablet PC, a notebook computer, a vehicle navigation system, or a game console, as well as a large-sized electronic device, such as a television or a monitor. The above examples are provided only as an example, and it is obvious that the display device DD may be implemented as another type of a display device without departing from the concept of the present disclosure. The display device DD is in a shape of a rectangle having a long side in the first direction DR1 and a short side in the second direction DR2 intersecting the first direction DR1. However, the shape of the display device DD is not limited thereto. For example, the display device DD may be implemented in various shapes. The display device DD may display an image IM in a third direction DR3 on a display surface IS parallel to each of the first direction DR1 and the second direction DR2. The display surface IS on which the image IM is displayed may correspond to a front surface of the display device DD.

In an embodiment, a front surface (or an upper/top surface) and a rear surface (or a lower/bottom surface) of each member are defined based on a direction in which the image IM is displayed. The front surface may be opposite to the rear surface in the third direction DR3, and a normal direction of each of the front surface and the rear surface may be parallel to the third direction DR3.

A separation distance between the front surface and the rear surface in the third direction DR3 may correspond to a thickness of the display device DD in the third direction DR3. Meanwhile, directions that the first, second, and third directions DR1, DR2, and DR3 indicate may be relative in concept and may be changed to different directions.

The display device DD may sense an external input applied from the outside. The external input may include various types of inputs that are provided from the outside of the display device DD. The display device DD according to an embodiment of the present disclosure may sense an external input of a user, which is applied from the outside. The external input of the user may be one of various types of external inputs, such as a part of his/her body, light, heat, his/her gaze, and pressure, or a combination thereof. Also, the display device DD may sense the external input of the user applied to a side surface or a rear surface of the display device DD depending on a structure of the display device DD and is not limited to an embodiment. As an example of the present disclosure, an external input may include an input entered through an input device (e.g., a stylus pen, an active pen, a touch pen, an electronic pen, or an E-pen).

The display surface IS of the display device DD may be divided into a display area DA and a non-display area NDA. The display area DA may be an area in which the image IM is displayed. A user perceives (or views) the image IM through the display area DA. In an embodiment, the display area DA is illustrated in the shape of a quadrangle whose vertexes are rounded. However, this is illustrated as an example. The display area DA may have various shapes, not limited to an embodiment.

The non-display area NDA is adjacent to the display area DA. The non-display area NDA may have a given color. The non-display area NDA may surround the display area DA. Accordingly, a shape of the display area DA may be defined substantially by the non-display area NDA. However, this is illustrated as an example. The non-display area NDA may be disposed adjacent to only one side of the display area DA or may be omitted. The display device DD according to an embodiment of the present disclosure may include various embodiments and is not limited to an embodiment.

As illustrated in FIG. 2, the display device DD may include a display module DM and a window WM disposed on the display module DM. The display module DM may include a display panel DP and an input sensing layer ISP.

According to an embodiment of the present disclosure, the display panel DP may include a light emitting display panel. For example, the display panel DP may be an organic light emitting display panel, an inorganic light emitting display panel, or a quantum dot light emitting display panel. A light emitting layer of the organic light emitting display panel may include an organic light emitting material. A light emitting layer of the inorganic light emitting display panel may include an inorganic light emitting material. A light emitting layer of the quantum dot light emitting display panel may include a quantum dot, a quantum rod, or the like.

The display panel DP may output the image IM, and the image IM thus output may be displayed through the display surface IS.

The input sensing layer ISP may be disposed on the display panel DP to sense an external input. The input sensing layer ISP may be directly disposed on the display panel DP. According to an embodiment of the present disclosure, the input sensing layer ISP may be formed on the display panel DP by a subsequent process. That is, when the input sensing layer ISP is directly disposed on the display panel DP, an inner adhesive film (not illustrated) is not interposed between the input sensing layer ISP and the display panel DP. However, the inner adhesive film may be interposed between the input sensing layer ISP and the display panel DP. In this case, the input sensing layer ISP is not manufactured together with the display panel DP through the subsequent processes. That is, the input sensing layer ISP may be manufactured through a process separate from that of the display panel DP and may then be fixed on an upper surface of the display panel DP by the inner adhesive film.

The window WM may be formed of a transparent material capable of outputting the image IM. For example, the window WM may be formed of glass, sapphire, plastic, etc. It is illustrated that the window WM is implemented with a single layer. However, an embodiment is not limited thereto. For example, the window WM may include a plurality of layers.

Meanwhile, although not illustrated, the non-display area NDA of the display device DD described above may correspond to an area that is defined by printing a material including a given color on one area of the window WM. As an example of the present disclosure, the window WM may include a light blocking pattern for defining the non-display area NDA. The light blocking pattern that is a colored organic film may be formed, for example, in a coating manner.

The window WM may be coupled to the display module DM through an adhesive film. As an example of the present disclosure, the adhesive film may include an optically clear adhesive (OCA) film. However, the adhesive film is not limited thereto. For example, the adhesive film may include a typical adhesive or sticking agent. For example, the adhesive film may include an optically clear resin (OCR) or a pressure sensitive adhesive (PSA) film.

An anti-reflection layer may be further disposed between the window WM and the display module DM. The anti-reflection layer decreases the reflectivity of external light incident from above the window WM. The anti-reflection layer according to an embodiment of the present disclosure may include a phase retarder and a polarizer. The phase retarder may have a film type or a liquid crystal coating type and may include a λ/2 phase retarder or a λ/4 phase retarder. The polarizer may also have a film type or a liquid crystal coating type. The film type may include a stretch-type synthetic resin film, and the liquid crystal coating type may include liquid crystals arranged in a given direction. The phase retarder and the polarizer may be implemented with one polarization film.

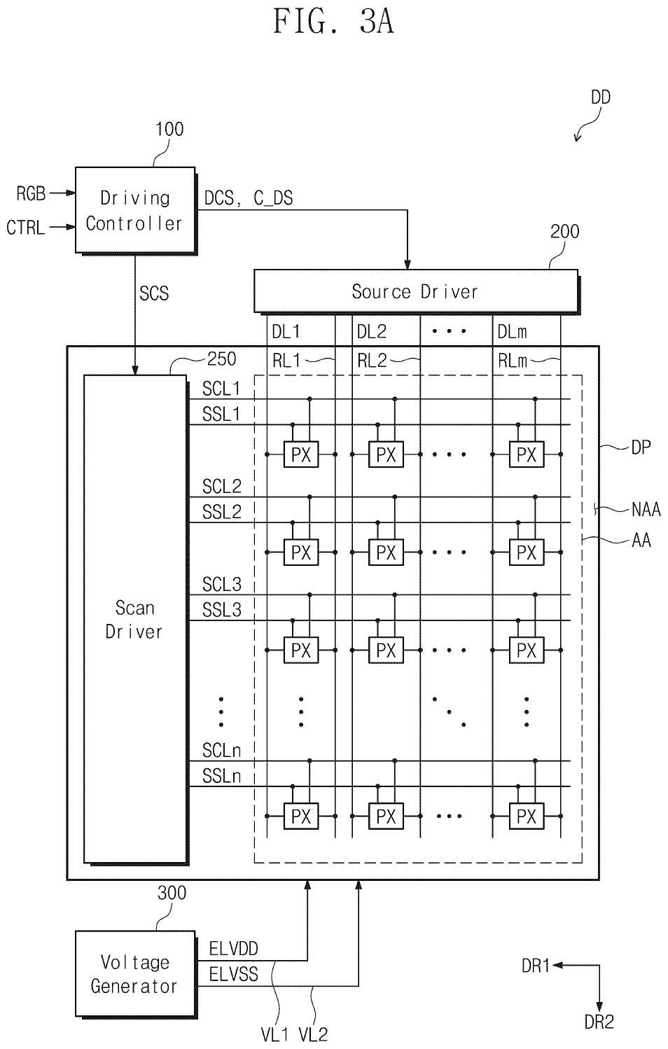

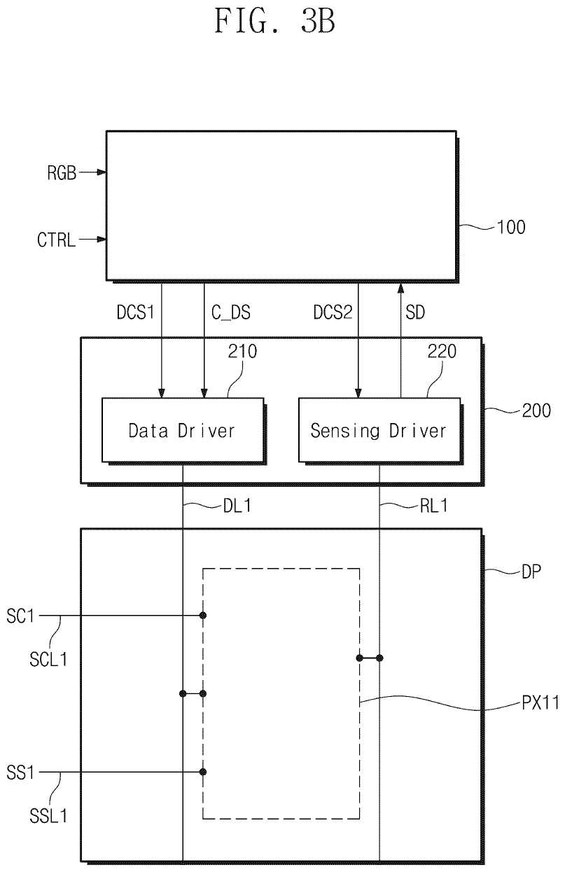

As an example of the present disclosure, the anti-reflection layer may also include color filters. The arrangement of the color filters may be determined in consideration of colors of light generated from a plurality of pixels PX (see FIG. 3A) included in the display panel DP. In this case, the anti-reflection layer may further include a light blocking pattern disposed between the color filters.

The display module DM may display the image IM depending on an electrical signal and may transmit/receive information about an external input. The display module DM may be defined by an active area AA and an inactive area NAA. The active area AA may be defined as an area (i.e., an area where the image IM is displayed) through which the image IM is output from the display panel DP. Also, the active area AA may be defined as an area in which the input sensing layer ISP senses an external input applied from the outside. According to an embodiment, the active area AA of the display module DM may correspond to (or overlap) at least part of the display area DA.

The inactive area NAA is adjacent to the active area AA. The inactive area NAA may be an area in which the image IM is not substantially displayed. For example, the inactive area NAA may surround the active area AA. However, this is illustrated by way of example. The inactive area NAA may be defined in various shapes, not limited to an embodiment. According to an embodiment, the inactive area NAA of the display module DM may correspond to (or overlap) at least part of the non-display area NDA.

The display device DD may further include a plurality of flexible films FF connected to the display panel DP. A driver chip or driver chips DIC (i.e. an integrated circuit or integrated circuits) may be mounted on each of the flexible films FF. As an example of the present disclosure, a source driver 200 (see FIG. 3A) may include a plurality of driver chips DIC, and the plurality of driver chips DIC may be respectively mounted on the plurality of flexible films FF.

The display device DD may further include at least one circuit board PCB coupled to the plurality of flexible films FF. As an example of the present disclosure, two circuit boards PCB are provided in the display device DD, but the number of circuit boards PCB is not limited thereto. The two circuit boards PCB may be electrically connected to each other by a connection film CF. Also, at least one of the two circuit boards PCB may be electrically connected to a main board. A driving controller 100 (see FIG. 3A) and a voltage generator 300 (see FIG. 3A) may be disposed on at least one of the two circuit boards PCB.

FIG. 2 illustrates a structure in which the driver chips DIC are respectively mounted on the flexible films FF, but the present disclosure is not limited thereto. For example, the driver chips DIC (or some of the driver chips DIC) may be directly mounted on the display panel DP. In this case, a portion of the display panel DP, on which the driver chips DIC are mounted, may be bent such that the driver chips DIC are disposed on a rear surface of the display module DM.

The input sensing layer ISP may be electrically connected to the circuit board PCB through the flexible films FF. However, an embodiment of the present disclosure is not limited thereto. That is, the display module DM may additionally include a separate flexible film for electrically connecting the input sensing layer ISP and the circuit board PCB.

The display device DD further includes a housing EDC for accommodating the display module DM. The housing EDC may be coupled with the window WM to define the exterior appearance of the display device DD. The housing EDC may absorb external shocks and may prevent a foreign material or moisture or the like from being infiltrated into the display module DM such that components accommodated in the housing EDC are protected. Meanwhile, as an example of the present disclosure, the housing EDC may be provided in the form of a combination of a plurality of accommodating members.

The display device DD according to an embodiment may further include an electronic module including various functional modules for operating the display module DM, a power supply module (e.g., a battery) for supplying a power necessary for overall operations of the display device DD, a bracket coupled with the display module DM or the housing EDC to partition an inner space of the display device DD, etc.

FIG. 3A is a block diagram of a display device, according to an embodiment of the present disclosure. FIG. 3B is a block diagram showing a driving controller and a source driver shown in FIG. 3A.

Referring to FIGS. 3A and 3B, the display device DD includes a driving controller 100, a source driver 200, a scan driver 250, a voltage generator 300, and a display panel DP. As an example of the present disclosure, the source driver 200 may include a data driver 210 and a sensing driver 220. The driving controller 100, the source driver 200, the scan driver 250, the voltage generator 300, the data driver 210, and the sensing driver 220 may be implemented combined or alone in one or more integrated circuits (e.g., the driving chip or driving chips DIC).

The display panel DP includes driving scan lines SCL1 to SCLn, sensing scan lines SSL1 to SSLn, data lines DL1 to DLm, a plurality of sensing lines RL1 to RLm, and pixels PX. The display panel DP may be divided into the active area AA and the inactive area NAA. The pixels PX may be disposed in the active area AA. The scan driver 250 may be disposed in the inactive area NAA.

The driving scan lines SCL1 to SCLn and the sensing scan lines SSL1 to SSLn extend in parallel with the first direction DR1 and are arranged spaced from each other in the second direction DR2. The second direction DR2 may be a direction intersecting the first direction DR1. The data lines DL1 to DLm extend from the source driver 200 in parallel with the second direction DR2 and are arranged spaced from each other in the first direction DR1. The sensing lines RL1 to RLm may extend in the second direction DR2 and may be arranged in the first direction DR1.

The plurality of pixels PX may be electrically connected to the driving scan lines SCL1 to SCLn, the sensing scan lines SSL1 to SSLn, the data lines DL1 to DLm, and the sensing lines RL1 to RLm. Each of the plurality of pixels PX may be electrically connected with two scan lines. For example, as shown in FIG. 3B, a first pixel PX11 among the plurality of pixels PX may be connected to a first driving scan line SCL1, a first sensing scan line SSL1, a first data line DL1, and a first sensing line RL1. However, the number of scan lines connected to each of the pixels PX is not limited thereto. For example, each pixel PX may be electrically connected to one or three scan lines.

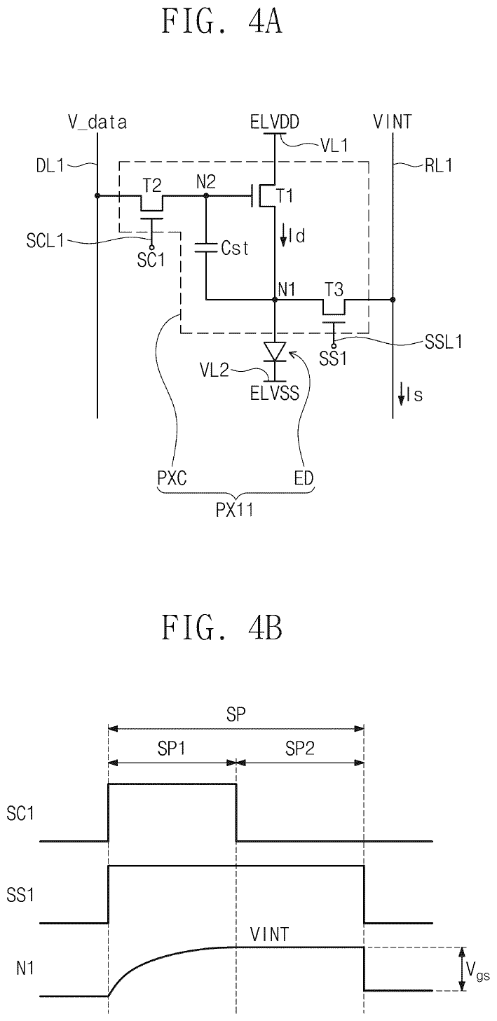

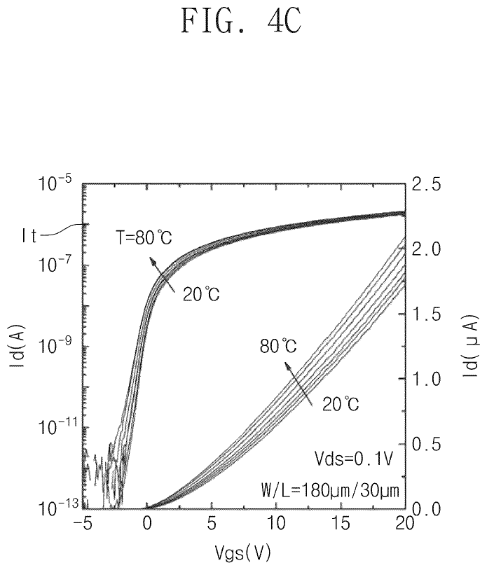

Each of the plurality of pixels PX includes a light emitting element ED (see FIG. 4A) and a pixel circuit unit PXC (see FIG. 4A) for controlling the emission of the light emitting element ED. The pixel circuit unit PXC may include a plurality of transistors and a capacitor.

The driving controller 100 receives an input image signal RGB and a control signal CTRL from a main controller (e.g., a microcontroller or a graphics controller). The driving controller 100 may generate compensation image data C_DS by converting the input image signal RGB.

The driving controller 100 generates a scan control signal SCS and a source control signal DCS based on the control signal CTRL. The source control signal DCS may include a data control signal DCS1 for controlling driving of the data driver 210 and a sensing control signal DCS2 for controlling driving of the sensing driver 220.

The data driver 210 receives the data control signal DCS1 from the driving controller 100. The data driver 210 converts the compensation image data C_DS into display data voltages (or display data signals) and outputs the display data voltages to the plurality of data lines DL1 to DLm. The display data voltages may be analog voltages corresponding to grayscale values of the compensation image data C_DS.

The sensing driver 220 receives the sensing control signal DCS2 from the driving controller 100. The sensing driver 220 may sense the display panel DP in response to the sensing control signal DCS2. The sensing driver 220 may sense characteristics of elements included in each of the pixels PX of the display panel DP from the plurality of sensing lines RL1 to RLm.

As an example of the present disclosure, the source driver 200 may be formed in a form of at least one chip (i.e. an integrated circuit). For example, when the source driver 200 is implemented as a single chip, the data driver 210 and the sensing driver 220 may be embedded in the chip. Moreover, when the source driver 200 is implemented as a plurality of chips (i.e. integrated circuits). The data driver 210 and the sensing driver 220 may be embedded in the plurality of chips, respectively.

A structure in which the data driver 210 and the sensing driver 220 are embedded in the source driver 200 is illustrated as an example, but the present disclosure is not limited thereto. For example, the data driver 210 and the sensing driver 220 may be formed in a form of separate chips. In this case, the data driver 210 may be disposed in the driver chips DIC shown in FIG. 2.

During a period (i.e., a power-on period) during which power is applied to the display device DD or a period (i.e., a power off period) during which a power supply is not supplied to the display device DD, the driving controller 100 may drive the sensing driver 220. Alternatively, during a specific period (e.g., a blank period), during which an image is not substantially displayed, from among operating periods during each of which the display device DD displays an image, the driving controller 100 may drive the sensing driver 220.

Elements such as the light emitting element ED or transistors included in the pixels PX deteriorate in proportion to a driving time, and driving characteristics (e.g., a threshold voltage) thereof may deteriorate. To compensate for the issues, the sensing driver 220 may sense the driving characteristics of the elements included in at least one of the pixels PX and may feed sensing data SD back to the driving controller 100. The controller 100 may compensate the input image signal RGB to be written in the pixels PX based on the sensing data SD fed back from the sensing driver 220.

The scan driver 250 receives the scan control signal SCS from the driving controller 100. The scan driver 250 may output scan signals in response to the scan control signal SCS. The scan driver 250 may be formed in a chip (i.e. an integrated circuit) form to be mounted on the display panel DP. Alternatively, the scan driver 250 may be embedded in the display panel DP. When the scan driver 250 is embedded in the display panel DP, the scan driver 250 may include transistors formed through the same process as the pixel circuit unit PXC.

The scan driver 250 may generate a plurality of driving scan signals and a plurality of sensing scan signals in response to the scan control signal SCS. The plurality of driving scan signals are applied to the driving scan lines SCL1 to SCLn. The plurality of sensing scan signals are applied to the sensing scan lines SSL1 to SSLn.

Each of the plurality of pixels PX may receive a first driving voltage ELVSS and a second driving voltage ELVDD.

The voltage generator 300 (e.g., an electronic module or an integrated circuit) generates voltages necessary to operate the display panel DP. In an embodiment of the present disclosure, the voltage generator 300 generates the first driving voltage ELVSS and the second driving voltage ELVDD, which are necessary for the operation of the display panel DP. The first driving voltage ELVSS and the second driving voltage ELVDD may be provided to the display panel DP through a first driving voltage line VL1 and a second driving voltage line VL2, respectively.

As well as the first driving voltage ELVSS and the second driving voltage ELVDD, the voltage generator 300 may further generate various voltages (e.g., a gamma reference voltage, a data driving voltage, a gate-on voltage, and a gate-off voltage) necessary for operations of the source driver 200 and the scan driver 250.

FIG. 4A is a circuit diagram illustrating a pixel, according to an embodiment of the present disclosure. FIG. 4B is a waveform diagram for describing an operation of a pixel and a sensing period shown in FIG. 4A. FIG. 4C is a graph showing driving characteristics according to temperature of a pixel, according to an embodiment of the present disclosure.

FIG. 4A shows an equivalent circuit diagram of a first pixel PX11 among the plurality of pixels PX shown in FIG. 3A. Because each of the plurality of pixels PX has the same circuit structure, a detailed description of the remaining pixels will be replaced with a description of a circuit structure of the first pixel PX11.

Referring to FIG. 4A, the first pixel PX11 is connected to the first data line DL1, the first driving scan line SCL1, the first sensing scan line SSL1, and the first sensing line RL1.

The first pixel PX11 includes the light emitting element ED and the pixel circuit unit PXC. The light emitting element ED may be a light emitting diode. As an example of the present disclosure, the light emitting element ED may be an organic light emitting diode including an organic light emitting layer. The light emitting element ED may be one of a red light emitting diode that emits red light, a green light emitting diode that emits green light, and a blue light emitting diode that emits blue light.

The pixel circuit unit PXC includes first to third transistors T1, T2, and T3 and a capacitor Cst. At least one of the first to third transistors T1, T2, and T3 may be a transistor having a low-temperature polycrystalline silicon (LTPS) semiconductor layer. Each of the first to third transistors T1, T2, and T3 may be an N-type transistor. However, the present disclosure is not limited thereto. Each of the first to third transistors T1, T2, and T3 may be a P-type transistor. Alternatively, some of the first to third transistors T1, T2, and T3 may be N-type transistors, and the other(s) thereof may be P-type transistors. Furthermore, at least one of the first to third transistors T1, T2, and T3 may be a transistor having an oxide semiconductor layer.

A configuration of the pixel circuit unit PXC according to the present disclosure is not limited to an embodiment illustrated in FIG. 4A. The pixel circuit unit PXC illustrated in FIG. 4A is only one example, and the configuration of the pixel circuit unit PXC may be modified and implemented. For example, in the pixel circuit unit PXC, the third transistor T3 may be omitted.

The first transistor T1 is connected between the first driving voltage line VL1 receiving the first driving voltage ELVDD and the light emitting element ED. The first transistor T1 includes a first electrode (i.e. a source or drain electrode) connected to the first driving voltage line VL1, a second electrode (i.e. a drain or source electrode) electrically connected to an anode of the light emitting element ED, and a third electrode (i.e. a gate electrode) connected to one end of the capacitor Cst. Here, a contact point where an anode of the light emitting element ED is connected to the second electrode of the first transistor T1 may be referred to as a “first node N1”. In this specification, “a transistor is connected to a signal line” means that one of a first electrode, a second electrode, and a third electrode of the transistor is integrated with a signal line or is connected through a connection electrode. Also, “a transistor is electrically connected to another transistor” means that one of a first electrode, a second electrode, and a third electrode of the transistor is integrated with one of a first electrode, a second electrode, and a third electrode of the other transistor, or is connected through a connection electrode”.

The first transistor T1 may receive a data voltage V_data transmitted through the first data line DL1 depending on the switching operation of the second transistor T2 and then may supply a driving current to the light emitting element ED.

The second transistor T2 is connected between the first data line DL1 and the third electrode of the first transistor T1. The second transistor T2 includes a first electrode (i.e. a source or drain electrode) connected to the first data line DL1, a second electrode (i.e. a drain or source electrode) connected to the third electrode of the first transistor T1, and a third electrode (i.e. a gate electrode) connected to the first driving scan line SCL1. Here, a contact point to which the second electrode of the second transistor T2 is connected to the third electrode of the first transistor T1 may be referred to as a “second node N2”. The second transistor T2 is turned on in response to a first driving scan signal SC1 received through the first driving scan line SCL1 and may provide the data voltage V_data transmitted from the first data line DL1 to the third electrode of the first transistor T1.

The third transistor T3 is connected between the second electrode of the first transistor T1 and the first sensing line RL1. The third transistor T3 includes a first electrode (i.e. a source or drain electrode) connected to the first node N1, a second electrode (i.e. a drain or source electrode) connected to the first sensing line RL1, and a third electrode (i.e. a gate electrode) connected to the first sensing scan line SSL1. The third transistor T3 is turned on in response to a first sensing scan signal SS1 received through the first sensing scan line SSL1 so as to electrically connect the first sensing line RL1 and the first node N1.

The one end of the capacitor Cst is connected to the second node N2, and the other end thereof is connected to the first node N1. The cathode of the light emitting element ED may be connected to the second driving voltage line VL2, through which the second driving voltage ELVSS is delivered. A voltage level of the second driving voltage ELVSS may be lower than a voltage level of the first driving voltage ELVDD.

The light emitting element ED may include the anode connected to the second electrode (or the first node N1) of the first transistor T1 and a cathode receiving the second driving voltage ELVSS. The light emitting element ED may generate light corresponding to the amount of the driving current supplied from the first transistor T1.

Referring to FIGS. 4A and 4B, during a sensing period SP, the first driving scan signal SC1 may be applied to the first driving scan line SCL1, and the first sensing scan signal SS1 may be applied to the first sensing scan line SSL1. The duration of the sensing period SP may be greater than the duration of an activation period of at least one sensing scan signal (e.g., the first sensing scan signal SS1) among sensing scan signals. An activation period of the first driving scan signal SC1 may overlap an activation period of the first sensing scan signal SS1. As an example of the present disclosure, the activation period of the first sensing scan signal SS1 may have longer duration (e.g., twice) than the activation period of the first driving scan signal SC1. As an example of the present disclosure, the activation period may be defined as a high level period.

The sensing period SP may include a write period SP1, in which the first driving scan signal SC1 and the first sensing scan signal SS1 are simultaneously activated, and a readout period SP2 in which only the first sensing scan signal SS1 is activated.

During the write period SP1, the second transistor T2 may be turned on in response to the first driving scan signal SC1, and the third transistor T3 may be turned on in response to the first sensing scan signal SS1.

A sensing data voltage V_data may be applied to the second node N2 (i.e., the third electrode of the first transistor T1) through the first data line DL1 and the turned-on second transistor T2. The sensing data voltage V_data may be a voltage applied to the data lines DL1 to DLm during the sensing period SP and may be a voltage set for current sensing. An initialization voltage VINT may be applied to the first node N1 (i.e., the second electrode of the first transistor T1 or the anode of the light emitting element ED) through the first sensing line RL1 and the turned-on third transistor T3. The initialization voltage VINT may be a voltage for initializing the first node N1.

A voltage between the first node N1 and the second node N2 may be set as a difference between the sensing data voltage V_data and the initialization voltage VINT. Electric charges corresponding to the difference between the sensing data voltage V_data and the initialization voltage VINT may be charged in the capacitor Cst. A voltage between the first node N1 and the second node N2 may be defined as a gate-source voltage Vgs of the first transistor T1.

Afterward, after the write period SP1 ends, when the first driving scan signal SC1 may be deactivated, the second transistor T2 may be turned off. When the write period SP1 ends, application of the initialization voltage VINT to the first sensing line RL1 may be stopped. Even though the second transistor T2 is turned off, the voltage between the first node N1 and the second node N2 may be maintained by the capacitor Cst during the readout period SP2.

Because the voltage between the first node N1 and the second node N2 is greater than the threshold voltage of the first transistor T1, a current (hereinafter referred to as a “drain current Id”) may flow through the first transistor T1 during the readout period SP2. During the readout period SP2, a potential of the first node N1 may be boosted by the drain current Id while the voltage between the first node N1 and the second node N2 is maintained. During the readout period SP2, the drain current Id may be output to the first sensing line RL1 through the turned-on third transistor T3. The drain current Id output through the first sensing line RL1 may be referred to as a “sensing current Is” (or a sensing signal). The sensing driver 220 (see FIG. 3B) may receive the sensing current Is through the first sensing line RL1, may convert the sensing current Is into the sensing data SD (see FIG. 3B), and may provide the converted data to the driving controller 100 (see FIG. 3B).

FIG. 4C is a diagram illustrating a current-voltage curve of the first transistor T1 according to temperature. In a state where a channel length (L) of the first transistor T1 is about 30 μm, a channel width (W) of the first transistor T1 is about 180 μm, and a drain-source voltage Vds of the first transistor T1 is about 0.1 V, a drain current Id for a gate-source voltage Vgs is measured. In particular, the current-voltage curve of FIG. 4C is measured while temperature is changed from about 20° ° C. to about 80° ° C. It is understood that a desired target current It (e.g., about 10⁻⁶ A) is reached even at a relatively low gate-source voltage Vgs as the temperature rises from about 20° ° C. to about 80° ° C.

In other words, to obtain the drain current Id corresponding to the target current It in a low temperature situation (e.g., about 20° C.), the gate-source voltage Vgs higher than the gate-source voltage Vgs in a high-temperature situation (e.g., about 80° C.) needs to be applied to the first transistor T1.

On the basis of the same gate-source voltage Vgs, as the temperature decreases, the drain current Id of the first transistor T1 may decrease.

In an embodiment of the present disclosure, in consideration of the temperature characteristics of the first transistor T1, the display data voltage applied to the pixel PX11 may be compensated depending on temperature.

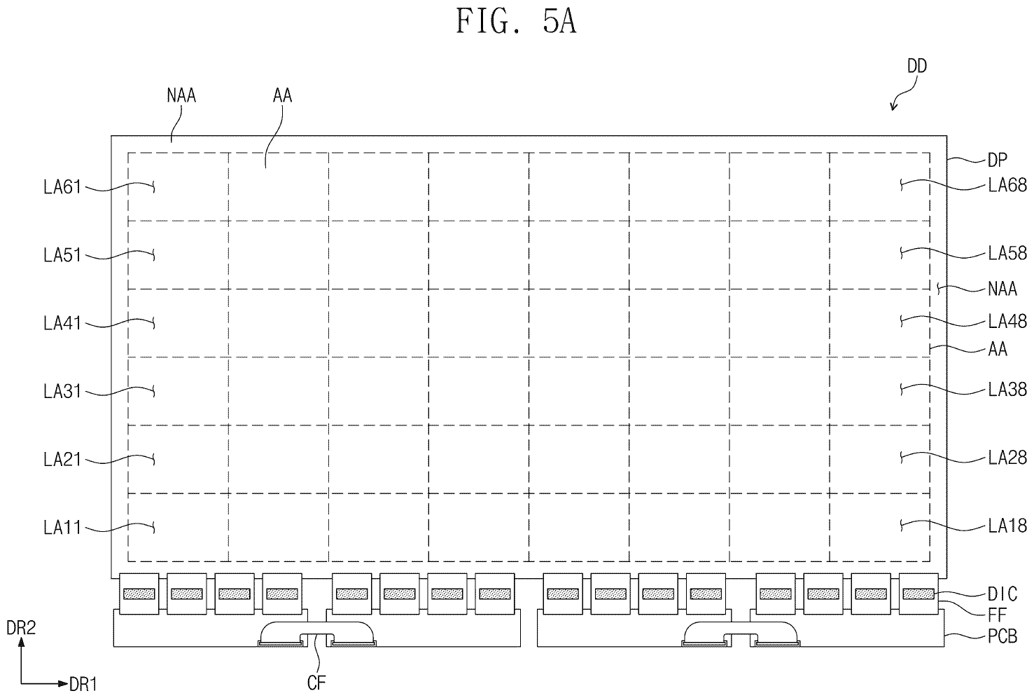

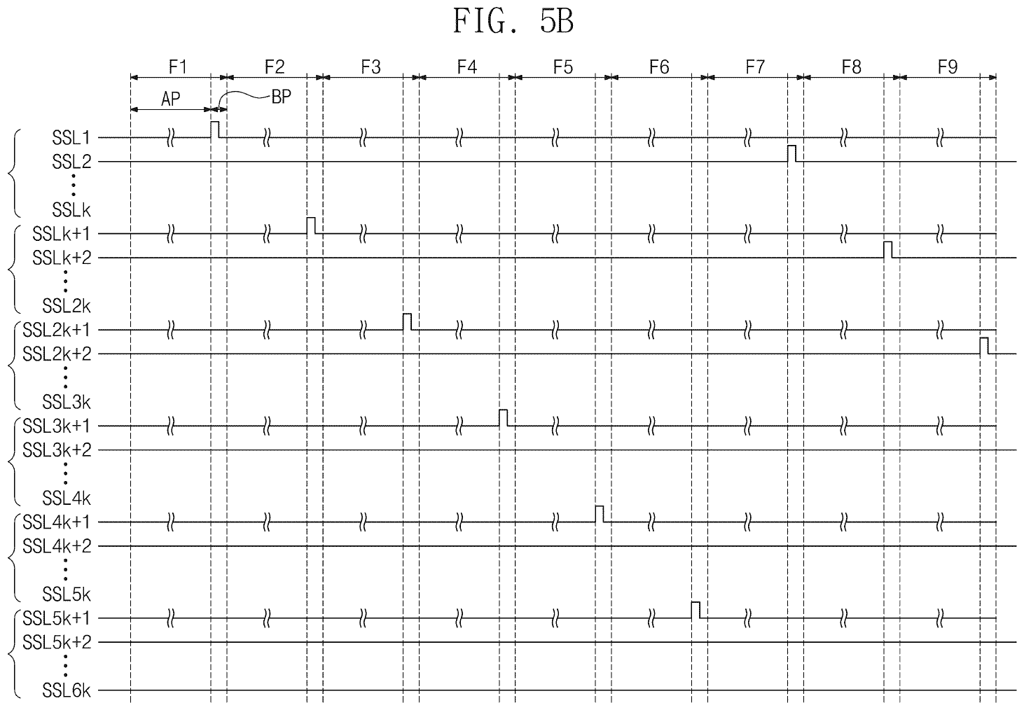

FIG. 5A is a plan view of a display device, according to an embodiment of the present disclosure. FIG. 5B is a waveform diagram illustrating operations of sensing scan lines, according to an embodiment of the present disclosure.

Referring to FIGS. 5A and 5B, the display panel DP according to an embodiment of the present disclosure includes the active area AA, in which the image IM (see FIG. 1) is displayed, and the inactive area NAA adjacent to the active area AA. The active area AA is an area where an image is actually displayed, and the inactive area NAA is a bezel area in which an image is not displayed. FIG. 5A shows a structure in which the inactive area NAA is positioned to surround the active area AA, but the present disclosure is not limited thereto. The inactive area NAA may be disposed only on at least one side of the active area AA.

The active area AA may include a plurality of block areas LA11 to LA68. The plurality of block areas LA11 to LA68 may be arranged in a matrix form in the first direction DR1 and the second direction DR2. As an example of the present disclosure, it is shown that the block areas LA11 to LA68 are arranged in a matrix form of 6×8. However, the number of block areas LA11 to LA68 is not particularly limited thereto. For example, the number of block areas LA11 to LA68 may vary depending on the size and resolution of the display panel DP.

For convenience of description, the plurality of block areas LA11 to LA68 may be divided into six row blocks. A first row block among the six row blocks includes eight block areas LA11 to LA18, a second row block among the six row blocks includes eight block areas LA21 to LA28, and a third row block among the six row blocks includes eight block areas LA31 to LA38. Moreover, a fourth row block among the six row blocks includes eight block areas LA41 to LA48, a fifth row block among the six row blocks includes eight block areas LA51 to LA58, and a sixth row block among the six row blocks includes eight block areas LA61 to LA68.

‘k’ sensing scan lines may be disposed in each row block to correspond to each row block. As an example of the present disclosure, ‘k’ sensing scan lines SSL1 to SSLk are positioned in the first row block LA11 to LA18 to correspond to the first row block LA11 to LA18. ‘k’ sensing scan lines SSLk+1 to SSL2k are positioned in the second row block LA21 to LA28 to correspond to the second row block LA21 to LA28. Here, ‘k’ may be an integer less than ‘n’. ‘k’ sensing scan lines SSL2k+1 to SSL3k are positioned in the third row block LA31 to LA38 to correspond to the third row block LA31 to LA38. ‘k’ sensing scan lines SSL3k+1 to SSL4k are positioned in the fourth row block LA41 to LA48 to correspond to the fourth row block LA41 to LA48. ‘k’ sensing scan lines SSL4k+1 to SSL5k are positioned in the fifth row block LA51 to LA58 to correspond to the fifth row block LA51 to LA58. ‘k’ sensing scan lines SSL5k+1 to SSL6k are positioned in the sixth row block LA61 to LA68 to correspond to the sixth row block LA61 to LA68. As an example of the present disclosure, ‘6k’ may be a value corresponding to ‘n’.

Referring to FIGS. 5A and 5B, during a plurality of frames, the display panel DP may display an image. In FIG. 5B, nine frames (hereinafter, referred to as “first to ninth frames F1 to F9”) are shown as an example. Each of the frames F1 to F9 may include an active period AP, in which an image is substantially displayed, and a blank period BP in which an image is not substantially displayed.

As an example of the present disclosure, the sensing scan lines SSL1 to SSL6k may be activated in the blank period BP in which an image is not displayed. During the blank period BP of the first frame F1, the first sensing scan line SSL1 among the ‘k’ sensing scan lines SSL1 to SSLk corresponding to the first row block LA11 to LA18 may be activated. Afterward, during the blank period BP of the second frame F2, the first sensing scan line SSLk+1 among the ‘k’ sensing scan lines SSLk+1 to SSL2k corresponding to the second row block LA21 to LA28 may be activated.

FIG. 5B shows that one sensing scan line is activated during the blank period BP of one frame (one of first to ninth frames F1 to F9), but the present disclosure is not limited thereto. During the blank period BP of one frame (one of F1 to F9), two or three sensing scan lines may be activated. For example, during the blank period BP of the first frame F1, the first sensing scan line SSL1 among the ‘k’ sensing scan lines SSL1 to SSLk and a first sensing scan line SSLk+1 among the ‘k’ scan lines SSLk+1 to SSL2k may be sequentially activated.

When the first sensing scan lines SSL1, SSLk+1, SSL2k+1, SSL3k+1, SSL4k+1, and SSL5k+1 respectively corresponding to the row blocks are sequentially activated during the first to sixth frames F1 to F6, representative sensing signals (i.e., it may be referred to as a block temperature of each block area) respectively corresponding to the row blocks may be provided to the driving controller 100 (see FIG. 3). On the basis of the correspondence to representative sensing signals, the driving controller 100 may calculate pixel temperatures corresponding to each of the pixels PX (see FIG. 3A) in an interpolation method.

Afterward, during the blank period BP of the seventh frame F7 after the seventh frame F7 starts, the second sensing scan line SSL2 among the ‘k’ sensing scan lines SSL1 to SSLk corresponding to the first row blocks LA11 to LA18 may be activated. Next, during the blank period BP of the eighth frame F8, the second sensing scan line SSLk+2 among the ‘k’ sensing scan lines SSLk+1 to SSL2k corresponding to the second row block LA21 to LA28 may be activated. During the blank period BP of the ninth frame F9, the second sensing scan line SSL2k+2 among the ‘k’ sensing scan lines SSL2k+1 to SSL3k corresponding to the third row block LA31 to LA38 may be activated.

In this manner, the driving controller 100 may receive the temperature (e.g., block temperature) of each of the block areas LA11 to LA68 every several frames, and then may calculate a pixel temperature for each of the pixels PX by applying the interpolation method based on the block temperature. Accordingly, without activating all sensing scan lines SSL1 to SSL6k, the pixel temperature for each of the pixels PX may be obtained quickly. As a result, it is possible to accurately sense the pixel temperature of each of the pixels PX in real time.

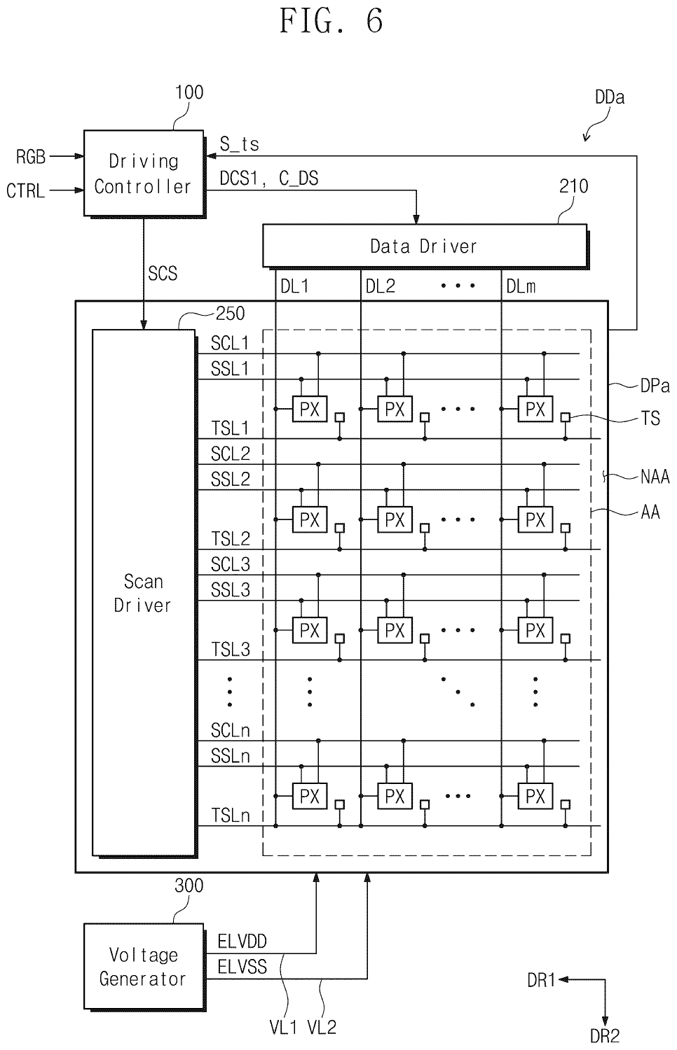

FIG. 6 is a block diagram of a display device, according to an embodiment of the present disclosure.

Referring to FIG. 6, in a display device DDa according to an embodiment of the present disclosure, a display panel DPa may include the plurality of pixels PX and a plurality of temperature sensors TS. As an example of the present disclosure, the plurality of temperature sensors TS may be provided in the display panel DPa in a matrix form. Under the same driving condition, each of the plurality of temperature sensors TS may include a sensing transistor in which an output current varies according to temperature. The display panel DPa may further include temperature scan lines TSL1 to TSLn for sensing the output current of each of the plurality of temperature sensors TS in units of row. The plurality of temperature sensors TS are electrically connected to the temperature scan lines TSL1 to TSLn and the sensing lines RL1 to RLm. As an example of the present disclosure, the temperature scan lines TSL1 to TSLn may extend in the first direction DR1 and may operate sequentially in the second direction DR2. FIG. 6 shows that the number of temperature scan lines TSL1 to TSLn, of which the number is ‘n’, is the same as the number of driving scan lines SCL1 to SCLn or the number of sensing scan lines SSL1 to SSLn (here, ‘n’ is an integer greater than or equal to ‘1’). However, the number of temperature scan lines TSL1 to TSLn may be less than the number of driving scan lines SCL1 to SCLn or the number of sensing scan lines SSL1 to SSLn.

As an example of the present disclosure, the scan driver 220 may be connected to the temperature scan lines TSL1 to TSLn to respectively apply temperature scan signals to the temperature scan lines TSL1 to TSLn. However, the present disclosure is not limited thereto. For example, the display device DD may further include a separate sensing scan driver for driving the temperature scan lines TSL1 to TSLn.

The temperature sensors TS may be disposed adjacent to each of the plurality of pixels PX of the display panel DPa to sense the temperature of adjacent pixel PX. When the corresponding sensing scan line is operating, the temperature sensors TS may output an output current corresponding to temperature as a sensing signal S_ts through the corresponding sensing line. Although not shown in drawings, the display panel DP may further include readout lines connected to the temperature sensors TS. Each readout line may output a sensing signal S_ts of the corresponding temperature sensor TS. The sensing signal S_ts sensed through the temperature sensor TS may be provided to the driving controller 100.

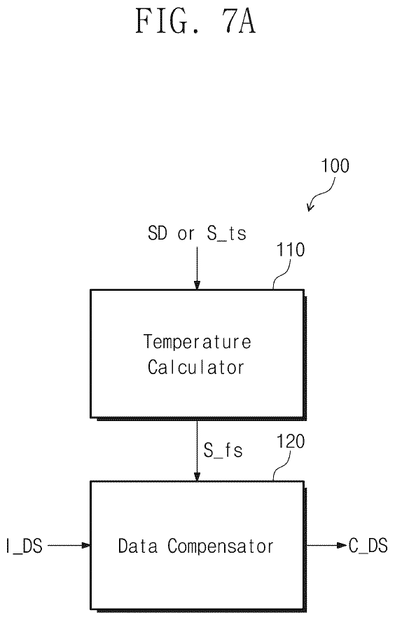

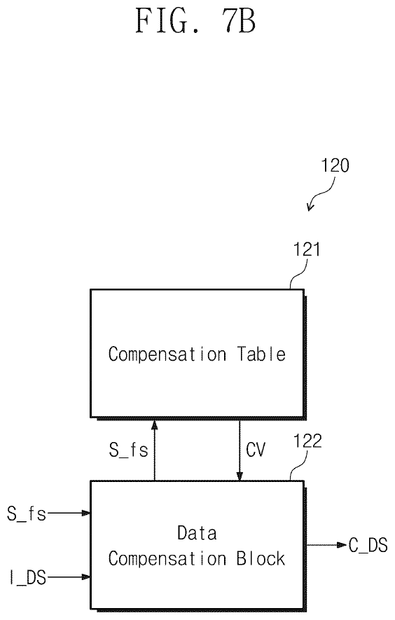

FIG. 7A is an internal block diagram of a driving controller, according to an embodiment of the present disclosure. FIG. 7B is an internal block diagram of a data compensator, according to an embodiment of the present disclosure.

Referring to FIGS. 3B, 5A, 5B, and 7A, the driving controller 100 according to an embodiment of the present disclosure includes a temperature calculator 110 and a data compensator 120. The temperature calculator 110 and the data compensator 120 may be implemented in one or more integrated circuits (e.g. the driving chip or chips DIC).

The temperature calculator 110 may receive the sensing data SD including temperature information of each of the pixels PX from the sensing driver 220. Alternatively, the temperature calculator 110 may be disposed adjacent to each of the plurality of pixels PX to receive the sensing signals S_ts output from the temperature sensors TS (see FIG. 6), each of which senses the temperature of the adjacent pixel PX.

The sensing data SD received by the temperature calculator 110 may be sensing data representing each of the block areas LA11 to LA68. The temperature calculator 110 may interpolate the sensing data SD in a predetermined interpolation method to sense the accurate temperature for each position (or pixel) of the display panel DP. In other words, when the corresponding first sensing scan lines SSL1 and SSLk+1 are activated, each of the two adjacent block areas (e.g., a 1-1 block area LA11 and a 2-1 block area LA21) may output sensing data corresponding to the sensing currents Is (see FIG. 4A) through the sensing lines RL1 to RLm. Here, sensing data corresponding to sensing currents output when the first sensing scan line SSL1 corresponding to the 1-1 block area LA11 is activated is referred to as “first sensing data”, and sensing data corresponding to the sensing currents output when the first sensing scan line SSLk+1 corresponding to the 2-1 block area LA21 is activated is referred to as “second sensing data”.

There are ‘k’ sensing scan lines between the first sensing scan line SSL1 corresponding to the 1-1 block area LA11 and the first sensing scan line SSLk+1 corresponding to the 2-1 block area LA21, and there are a plurality of pixels connected to ‘k’ sensing scan lines. The temperature calculator 110 may not receive intermediate sensing data corresponding to each intermediate sensing current of each of a plurality of pixels (i.e., intermediate pixels) between the sensing scan lines SSL1 and SSLk+1. However, the temperature calculator 110 may calculate (or obtain) intermediate sensing data by using first and second sensing data in a predetermined interpolation method.

The temperature calculator 110 may calculate pieces of final sensing data S_fs for all the pixels PX in the interpolation method, and may provide the pieces of final sensing data S_fs calculated in the interpolation method to the data compensator 120. The pieces of final sensing data S_fs may include temperature information for each of the pixels PX. The pieces of final sensing data S_fs may be updated at a predetermined period (e.g., several frames).

Referring to FIGS. 7A and 7B, the pieces of final sensing data S_fs are provided to the data compensator 120. The data compensator 120 may include a compensation table 121 and a data compensation block 122. The compensation table 121 and the data compensation block 122 may be implemented in one or more integrated circuits (e.g. the driving chip or chips DIC).

The data compensation block 122 receives the pieces of final sensing data S_fs from the temperature calculator 110, and receives the image data I_DS generated by converting the input image signal RGB (see FIG. 3A) inside the driving controller 100 (see FIG. 3A). The data compensation block 122 may read out an appropriate compensation value CV from the compensation table 121 based on the pieces of final sensing data S_fs and the image data I_DS.

The compensation value CV different depending on temperature may be stored in the compensation table 121. A compensation value at a point in time when red image data having the highest grayscale at temperature of about 30° C. is input to the data compensation block 122 may be different from a compensation value at a point in time when red image data having the highest grayscale at temperature of about 45° C. is input to the data compensation block 122. Different compensation values may be stored in the compensation table 121 for each grayscale and color depending on temperature. For example, the compensation value at a point in time when red image data having the highest grayscale at temperature of about 30° C. is input to the data compensation block 122 may be different from a compensation value at a point in time when green image data having the highest grayscale at temperature of about 30° C. is input to the data compensation block 122. Moreover, the compensation value at a point in time when red image data having the highest grayscale at temperature of about 30° C. is input to the data compensation block 122 may be different from a compensation value at a point in time when red image data having the lowest grayscale at temperature of about 30° C. is input to the data compensation block 122.

The compensation values CV stored for each grayscale and each color according to temperature may vary depending on basic characteristics such as the size and resolution of the display device DD (see FIG. 1). Accordingly, under the same temperature, the same color, or the same grayscale conditions, different compensation values may be stored in the compensation table 121 of the display device DD having different basic characteristics.

The data compensation block 122 may compensate for the image data I_DS based on the compensation value CV read from the compensation table 121. The data compensation block 122 may compensate for the image data I_DS and then may output the compensation image data C_DS. Afterward, the compensation image data C_DS may be provided to the data driver 230 (see FIG. 3) to be converted into a data voltage (or data signal).

When two pixels (i.e., first and second pixels) having the same color as each other have different temperatures from each other, two pieces of color image data (i.e., first color image data and second color image data), which correspond to the two pixels, from among the image data I_DS may have the same value in the same grayscale. In this case, a luminance difference according to temperature may occur between the two pixels. However, when the two pixels having the same color as each other have different temperatures from each other, two pieces of color compensation data corresponding to two pixels of the compensation image data C_DS may have different values in the same grayscale. When temperature corresponding to the first pixel is higher than temperature corresponding to the second pixel, the first color image data may have a lower value than the second color image data in the same grayscale. In other words, when two pieces of color compensation data having values different according to temperature in the same grayscale are respectively provided to the two pixels, a luminance difference according to temperature may not occur between the two pixels.

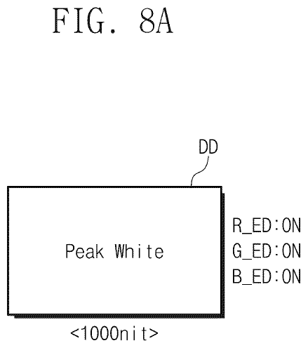

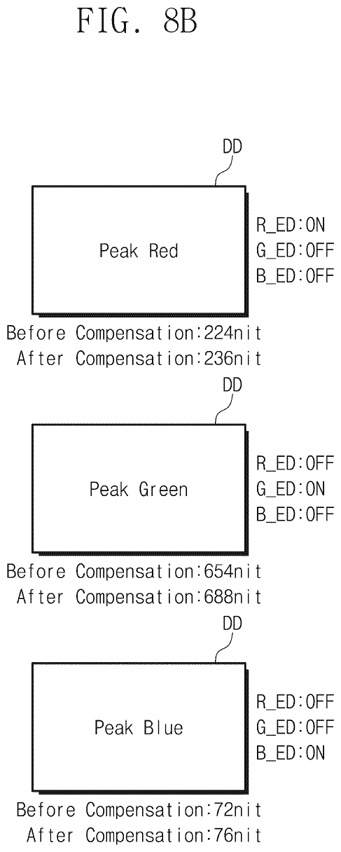

FIG. 8A is a diagram, in which a display device displays a peak white image, according to an embodiment of the present disclosure. FIG. 8B is a diagram, in which a display device individually displays a peak red image, a peak green image, and a peak blue image, according to an embodiment of the present disclosure.

Referring to FIG. 8A, the display device DD may display a white image in a reference grayscale. When the reference grayscale is the highest grayscale, a white image (i.e., a peak white image) having the highest grayscale may be displayed on the display device DD. The peak white image may have a luminance of approximately 1000 nits. The luminance of the peak white image may vary depending on a percentage at which the peak white image occupies boxes in the whole screen. For example, when the peak white image is displayed in about 10% of boxes on the whole screen, and the remaining boxes having about 90% display a black image, the luminance of the peak white image may be measured as about 450 nits. For example, when a peak white image is displayed in 3% of boxes on the whole screen, and the remaining boxes having about 97% display a black image, the luminance of the peak white image may be measured as about 1000 nits.

When a white image is displayed, red light emitting elements R_ED (or first light emitting elements), green light emitting elements G_ED (or second light emitting elements), and blue light emitting elements B_ED (or third light emitting elements) located in an area where a white image is displayed may be turned on at the same time. In other words, because the red, green and blue light emitting elements R_ED, G_ED, and B_ED are turned on at the same time when the white image is displayed, the overall temperature of the display device DD may increase. For example, when a peak white image having luminance of about 1000 nits is displayed on the display device DD, the temperature measured through each pixel PX (see FIG. 3A) in the corresponding area may be about 40° C.

Referring to FIG. 8B, the display device DD may display only a red image having a reference grayscale, may display only a green image having the reference grayscale, or may display only a blue image having the reference grayscale. When the reference grayscale is the highest grayscale, only the red image (i.e., a peak red image) having the highest grayscale may be displayed; only the green image (i.e., a peak green image) having the highest grayscale may be displayed; or, only the blue image (i.e., a peak blue image) having the highest grayscale may be displayed.

When only a red image is displayed, the red light emitting elements R_ED located in an area where the red image is displayed may be turned on, but the green light emitting elements G_ED and the blue light emitting elements B_ED may be turned off. When only a green image is displayed, the green light emitting elements G_ED located in an area where the green image is displayed may be turned on, but the red light emitting elements R_ED and the blue light emitting elements B_ED may be turned off. When only a blue image is displayed, the blue light emitting elements B_ED located in an area where the blue image is displayed may be turned on, but the red light emitting elements R_ED and the green light emitting elements G_ED may be turned off.

When a single color image is displayed, only the light emitting element corresponding to one color among the red, green, and blue light emitting elements R_ED, G_ED, and B_ED is turned on and light emitting elements corresponding to the remaining colors are turned off. Accordingly, the overall temperature of the display device DD may decrease as compared to a case where light emitting elements of all colors are simultaneously turned on to display a white image. In other words, when only the peak red image is displayed, temperature measured through each pixel PX in the corresponding area where the peak red image is displayed may be lower than temperature (i.e., about 40° C.) measured when the peak white image is displayed. Moreover, when only the peak green image is displayed, temperature measured through each pixel PX in the corresponding area where the peak green image is displayed may be lower than temperature (i.e., about 40° C.) measured when the peak white image is displayed. Likewise, when only the peak blue image is displayed, temperature measured through each pixel PX in the corresponding area where the peak blue image is displayed may be lower than temperature (i.e., about 40° C.) measured when the peak white image is displayed.

As shown in FIG. 4C, when temperature decreases, the output current Id of the first transistor T1 decreases based on the same gate-source voltage Vgs. Before the image data I_DS is compensated depending on the sensed temperature (i.e., before compensation), by these temperature characteristics, the peak red image has a luminance of about 224 nit, the peak green image has a luminance of about 654 nits, and, the blue light emitting element has a luminance of about 72 nits. Before the compensation, the total luminance (hereafter, referred to as “second luminance”) obtained by summing the luminance of the peak red image, the luminance of the peak green image, and the luminance of the peak blue image may be about 950 nit, and may be smaller than the luminance (hereafter, referred to as “first luminance”) (i.e., about 1000 nit) of the peak white image.

As the deviation between the first luminance and the second luminance increases, the color characteristics of the display device DD may deteriorate. Accordingly, according to an embodiment of the present disclosure, the deviation between the first luminance and the second luminance may have a value less than or equal to the set reference deviation within a range in which color characteristics are not degraded.

As illustrated in FIGS. 7B and 8B, when one color image is displayed in a reference grayscale by driving a light emitting element corresponding to one color among red, green, and blue light emitting elements R_ED, G_ED, and B_ED, the compensation image data C_DS may be created by detecting a temperature drop in real time and compensating for the image data I_DS depending on the lowered temperature. In this case (i.e., after the compensation), the peak red image may have a luminance of 236 nits; the peak green image may have a luminance of 688 nits; and, the blue light emitting element may have a luminance of 76 nits.

In other words, after the compensation, the total luminance (i.e., the second luminance) obtained by summing the luminance of the peak red image, the luminance of the peak green image, and the luminance of the peak blue image may be 1000 nits, and may be the same as the luminance (i.e., the first luminance) of the peak white image.

As such, the luminance deviation according to the temperature may be reduced by sensing temperature in real time. As a result, the overall display quality of the display device DD may be improved.

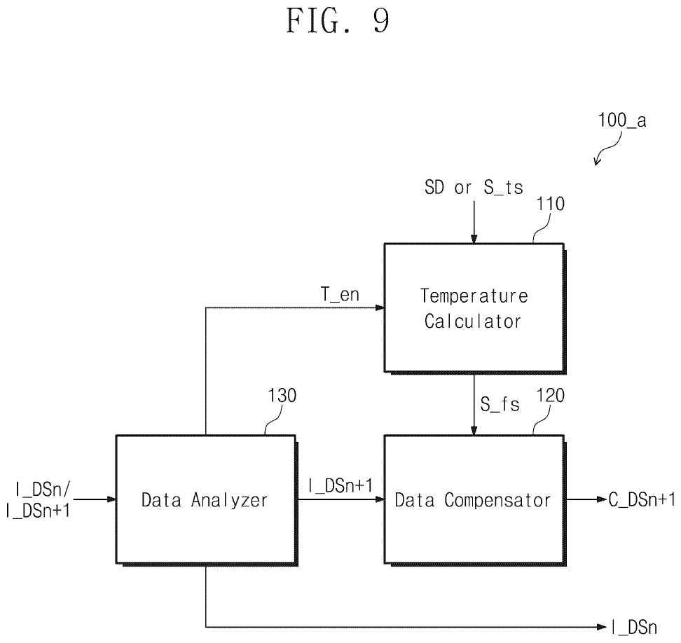

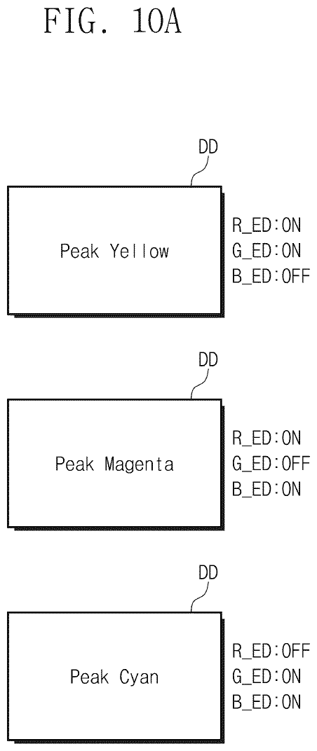

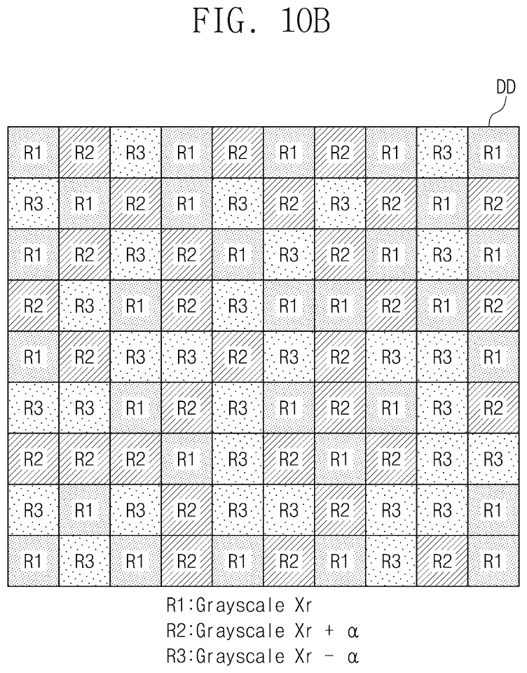

FIG. 9 is an internal block diagram of a driving controller, according to an embodiment of the present disclosure. FIG. 10A is a diagram, in which a display device individually displays a peak yellow image, a peak magenta image, and a peak cyan image, according to an embodiment of the present disclosure. FIG. 10B is a diagram, in which a display device displays a red image having a grayscale within a reference grayscale range, according to an embodiment of the present disclosure. Components, which are equal to the components illustrated in FIG. 7A, from among components illustrated in FIG. 9 are marked by the same reference signs, and thus, additional description will be omitted to avoid redundancy.

Referring to FIG. 9, a driving controller 100_a according to an embodiment of the present disclosure may include the temperature calculator 110, the data compensator 120, and a data analyzer 130. The driving controller 100_a, the temperature calculator 110, the data compensator 120, and the data analyzer 130 may be implemented in one or more integrated circuits (e.g. the driving chip or chips DIC).

The data analyzer 130 may receive image data in units of one frame. Here, image data provided to the data analyzer 130 during an n-th frame may be referred to as “current frame data I_DSn”, and image data provided to the data analyzer 130 during an (n+1)-th frame may be referred to as “next frame data I_DSn+1”.

The data analyzer 130 may receive the current frame data I_DSn and may analyze whether the current frame data I_DSn is data including one color image or two color images. When the current frame data I_DSn includes one color image or two color images, the data analyzer 130 may generate an enable signal T_en for activating the temperature calculator 110. For example, when the current frame data I_DSn includes only one red image or includes only a red image and a green image (i.e., two color images) (that is, when it corresponds to a specific condition), the data analyzer 130 may generate the enable signal T_en. The data analyzer 130 may analyze frame data during several frames or dozens of frames, and may determine whether the frame data corresponds to the specific condition, by accumulating the analysis result.

However, even when it is determined that the current frame data I_DSn is satisfies the specific condition during a current frame, the temperature calculator 110 has been inactive during a previous frame. Accordingly, the temperature calculator 110 may not generate final sensing data to be used to compensate for the current frame data I_DSn. Accordingly, the current frame data I_DSn may not be provided to the data compensator 120 and may be output without compensation.

When the temperature calculator 110 is activated in response to the enable signal T_en, the final sensing data S_fs may be provided to the data compensator 120 during the next frame. The data analyzer 130 may provide the next frame data I_DSn+1 to the data compensator 120, and the data compensator 120 may output compensation image data C_DSn+1 by compensating for the next frame data I_DSn+1 based on the final sensing data S_fs.

FIG. 9 illustrates that the next frame data I_DSn+1 is compensated to the compensation image data C_DSn+1 during the next frame, but the present disclosure is not limited thereto. That is, when the temperature calculator 110 takes a predetermined time (e.g., several frames) to calculate the final sensing data S_fs, the data compensator 120 may compensate for frame data after several frames have elapsed from the current frame.

As illustrated in FIG. 8B, a case where the display device DD displays only a peak red image, only a peak green image, or only a peak blue image may correspond to a specific condition (hereinafter referred to as a “first specific condition”) for displaying one color image.

Even under a specific condition (hereinafter referred to as a “second specific condition”) two color images are simultaneously displayed, the display device DD may activate the temperature calculator 110 and the data compensator 120.

As illustrated in FIG. 10A, a case where a peak yellow image is displayed by simultaneously displaying the peak red image and the peak green image, a magenta yellow image is displayed by simultaneously displaying the peak red image and the peak blue image, and a cyan image is displayed by simultaneously displaying the peak green image and the peak blue image may correspond to the second specific condition.

As such, when compensation is performed by activating the temperature calculator 110 and the data compensator 120 only when a specific condition is satisfied through the data analyzer 130, an increase in power consumption of the display device DD may be prevented while display characteristics according to temperature are improved.

As illustrated in FIG. 10B, when a red image having a grayscale within a reference grayscale range is displayed, the data analyzer 130 may determine that the first specific condition is satisfied. In particular, the display device DD may include a first red area R1 where the first red image having a first grayscale is displayed, a second red area R2 where a second red image having a second grayscale is displayed, and a third red area R3 where a third red image having a third grayscale is displayed. Here, the first grayscale may correspond to a reference grayscale Xr, the second grayscale may correspond to a grayscale Xr+α greater than the reference grayscale Xr by an error value α, and, the third grayscale may correspond to a grayscale Xr−α smaller than the reference grayscale Xr by the error value α. As an example of the present disclosure, the error value α may be set to a value less than or equal to a grayscale of 4.

Here, the reference grayscale range may be set to a range corresponding to a range between the third grayscale Xr−α and the second grayscale Xr+α. That is, even when the red image does not exactly correspond to the reference grayscale Xr and has a grayscale that is present within an error range between Xr−α and Xr+α, it may be determined that the red image is a single color image having a single grayscale.

A red image may be shown in FIG. 10B. However, when a single color image having a single grayscale is determined even in green and blue images, it may be determined by applying the above reference grayscale range.

Although embodiments of the present disclosure have been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification, but should be defined by the claims.

According to an embodiment of the present disclosure, without activating all sensing scan lines, the temperature of each of pixels may be quickly obtained. As a result, the temperature of each of the pixels may be accurately sensed in real time.

Moreover, a phenomenon that display characteristics vary depending on temperature may be removed or prevented by compensating for image data based on the sensed temperature to generate compensation image data and displaying an image by using the compensation image data.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A display device comprising:
a display panel including a plurality of pixels, wherein each of the pixels includes one of a first light emitting element, a second light emitting element, and a third light emitting element;
a temperature calculator configured to sense a block temperature for each of a plurality of block areas partitioned in the display panel and to calculate temperature of each of the plurality of pixels based on the block temperature; and
a data compensator configured to generate compensation image data by compensating for image data corresponding to each of the pixels depending on the temperature.

2. The display device of claim 1, wherein a deviation between a first luminance, which is measured when a white image is displayed in a reference grayscale by driving the first light emitting element, the second light emitting element, and the third light emitting element, and a second luminance corresponding to a sum of luminances measured when a specific color image is displayed in the reference grayscale by individually driving the first light emitting element, the second light emitting element, and the third light emitting element is less than or equal to a predetermined reference deviation.

3. The display device of claim 2, wherein, when the plurality of pixels include a first pixel and a second pixel, which have the same color as each other, and temperature corresponding to the first pixel is different from temperature corresponding to the second pixel, the compensation image data includes first color compensation data and second color compensation data respectively corresponding to the first pixel and the second pixel, and
wherein the first color compensation data and the second color compensation data have different values from each other in the same grayscale.

4. The display device of claim 3, wherein the temperature corresponding to the first pixel is higher than the temperature corresponding to the second pixel, and
wherein the first color image data has a lower value than the second color image data in the same grayscale.

5. The display device of claim 1, wherein the data compensator includes:
a compensation table configured to store a compensation value for each grayscale of each color according to the temperature; and
a data compensation block configured to read out compensation values corresponding to the temperature with reference to the compensation table and to compensate for the image data to the compensation image data based on the compensation values.

6. The display device of claim 1, wherein the display panel displays an image in units of a frame, and
wherein the frame includes an active period and a blank period.

7. The display device of claim 6, wherein the display panel further includes a plurality of sensing scan lines connected to the plurality of pixels, and
wherein at least one sensing scan line among the plurality of sensing scan lines is activated during the blank period.

8. The display device of claim 7, wherein the temperature calculator receives sensing data corresponding to the block temperature of a block area corresponding to the at least one sensing scan line from pixels connected to the at least one sensing scan line, and calculates final sensing data of each of pixels belonging to the respective block area based on the sensing data.

9. The display device of claim 8, wherein the temperature calculator calculates the final sensing data by interpolating the sensing signals through a predetermined interpolation method.

10. The display device of claim 8, wherein the temperature calculator provides the final sensing data to the data compensator at a predetermined period.

11. The display device of claim 1, further comprising:
a data analyzer configured to analyze the image data and to activate the temperature calculator when the image data satisfies a specific condition.

12. The display device of claim 11, wherein the data analyzer activates the temperature calculator under a first specific condition that a specific color image is displayed by driving one light emitting element of the first light emitting element, the second light emitting element, and the third light emitting element, or a second specific condition that a specific color image is displayed by driving two light emitting elements among the first light emitting element, the second light emitting element, and the third light emitting element.

13. The display device of claim 12, wherein, under the first specific condition, the specific color image has one reference grayscale.

14. The display device of claim 12, wherein, under the first specific condition, the specific color image has a grayscale within a reference grayscale range.

15. The display device of claim 14, wherein the reference grayscale range is set to a range between a grayscale smaller than a reference grayscale by an error value and a grayscale greater than the reference grayscale by the error value.

16. The display device of claim 15, wherein the error value is a value less than or equal to a grayscale of 4.

17. The display device of claim 12, wherein, under the second specific condition, the specific color image is an image obtained by mixing two color images.

18. The display device of claim 11, wherein the data analyzer receives the image data in units of frame, analyzes the image data during several frames or tens of frames, and determines whether the image data corresponds to the specific condition, by accumulating the analysis result.

19. The display device of claim 1, further comprising:
a source driver configured to convert the compensation data into a data signal and to provide the data signal to the display panel; and
a driving controller configured to control driving of the source driver,
wherein the driving controller includes the temperature calculator and the data compensator.

20. The display device of claim 19, wherein the driving controller further includes a data analyzer configured to analyze the image data and to activate the temperature calculator when the image data satisfies a specific condition.

21. A display device comprising:
a display panel including a plurality of pixels, wherein each of the pixels includes one of a first light emitting element, a second light emitting element, and a third light emitting element;
one or more integrated circuits configured to:
sense a block temperature for each of a plurality of block areas partitioned in the display panel;
calculate temperature of each of the plurality of pixels based on the block temperature;
generate compensation image data; and
compensate an image using the compensation image data corresponding to each of the pixels depending on temperature.
